(19) United States
(12) Patent Application Publication
(10) Pub. No.: US 2006/0099400 A1
(43) Pub. Date: May 11, 2006

(54) Coated paper for photogravure

(76) Inventors: Koji Okomori, Tokyo (JP); Masato Yamaguchi, Tokyo (JP); Kazuaki Minehata, Tokyo (JP); Hirokazu Morii, Tokyo (JP)

Correspondence Address: NIXON & VANDERHYE, PC, 901 NORTH GLEBE ROAD, 11TH FLOOR, ARLINGTON, VA, 22203, US

(21) Appl. No.: 10/527,328

(22) PCT Filed: Sep. 11, 2003
(86) PCT No.: PCT/JP03/11641

§ 371 Date: Sep. 22, 2005

(30) Foreign Application Priority Data
Sep. 11, 2002 (JP) 2002-266155

(51) Int. Cl. B32B 3/00; B32B 5/16; B32B 29/00

(52) U.S. Cl. 428/313.5; 428/327; 428/323; 428/330; 428/537.5

(57) ABSTRACT

The present invention relates to rotogravure coated papers and provides rotogravure coated papers having good operability, low density, high gloss and good printability. Disclosed are rotogravure coated papers comprising a coating layer containing a pigment and an adhesive on a base paper, wherein the coating layer contains an inorganic pigment having a volume-based distribution in which 65% or more of particles are in the particle diameter range of 0.4-4.2 μm and a hollow sphere synthetic pigment having a mean particle diameter of 0.1-0.6 μm.

### TECHNICAL FIELD

The present invention relates to rotogravure coated papers with good coating runnability, low density, high gloss and good printability, as well as to processes for preparing the rotogravure coated papers.

### PRIOR ART

Gravure printing is a kind of intaglio printing process in which ink is applied in recessed areas in the printing plate and transferred under pressure, and it is used in the field of commercial printing of, for example, magazines, catalogs and brochure or the like because of the excellent gradation reproducibility.

In contrast to offset printing, gravure printing uses hard metal rolls as printing plates, which are difficult to completely press against paper, thus causing missing dots during gravure printing. For this reason, base papers and coating layers for rotogravure coated papers should have smoothness and cushioning properties and the like.

Rotogravure coated papers are given smoothness typically being treated by supercalendering at high linear pressures or the like, but coated papers calendered at high pressures have high density despite the smooth surfaces of the coating layers.

In recent years, there has been a preference for light to heavy books, to avoid increasing postal charges and other influences. This translates into a need for lighter-weight papers. A growing environmental awareness also inevitably requires weight reduction of papers in order to effectively utilize papermaking pulp prepared from forest resources, and the trend toward weight reduction also prevails in the field of rotogravure coated papers.

Approaches to weight reduction by conventional processes for preparing rotogravure coated papers result in low opacity and lack of stiffness. If rotogravure coated papers are produced by conventional techniques, print gloss also deteriorates because the coat weight must also be reduced to reduce the basis weight.

Generally, papers must be bulky to improve opacity and stiffness. A means to reduce paper density is to choose papermaking pulp, which is the main raw material of papers. Wood pulps are commonly used as papermaking pulp. Mechanical pulps prepared by grinding wood with refiners or grinders without using chemicals contain stiffer fibers than chemical pulps prepared by extracting a reinforcing component lignin in fibers with chemicals, and therefore, the former are more advantageous for density reduction. Among them, ground wood pulps (GPs) greatly contribute to density reduction. Normally, papermaking pulp is fibrillated by beating to soften fibers, but beating is incompatible with density reduction and should be minimized to attain density reduction.

The choice of the wood species from which pulp is prepared also greatly influences the density of paper. That is, density reduction is feasible when wood fibers themselves are coarser. For example, hardwood species from which relatively low density papers are obtained include gumwood, maple, birch, etc. However, it is difficult to collect only these wood species and process them into pulp against the current wave of environmentalism.

The recent wave of environmentalism and the necessity of resource conservation call for inclusion of higher proportions of recycled pulps. However, recycled pulps tend to have higher density than virgin mechanical pulps because waste papers are mostly pulped in a mixed state but there are few cases in which they are definitely sorted by paper quality into woodfree papers, newspapers, magazines, dodgers, coated papers, etc. before they are pulped. A reason for this is that fibers in recycled pulps are mixtures of chemical and mechanical pulps. Moreover, the inclusion of talc, kaolin and clay commonly used as fillers in papers or filler components in coated papers tends to increase density. Thus, inclusion of higher proportions of recycled pulps tends to increase paper density.

As described above, opacity and stiffness are insufficient even if coating base papers for gravure printing are prepared by conventional techniques with pulps only changed, and it is difficult to prepare light-weight rotogravure coated papers by only this approach.

Possible means intervening in the paper machine process to reduce density include using a roller pressure as low as possible at the pressing stage and eliminating the calendering step for conferring smoothness on paper surfaces.

In addition to these approaches intervening in the pulping and paper machine processes, another approach involves the filler composition, which is the second major component to the coating base paper. For example, JPB SHO 52-118116 discloses a method for achieving density reduction by including capsules of hollow synthetic organic materials as fillers. Synthetic organic fillers that are expandable by heat in the dryer section during the paper machine process to achieve density reduction have also been proposed (e.g. available from Japan Fillite Co., Ltd. under trade name EXPANCEL). However, drying conditions during the paper machine process are complex in the method using these synthetic organic expandable fillers, and even if rotogravure coated papers are prepared by only adopting this method, it is difficult to prepare rotogravure coated papers with low density and good print gloss.

An alternative to the approach involving the filler composition was also proposed by adding microfibrillated cellulose as shown in JPA HEI 8-13380. In this method using microfibrillated cellulose, the microcellulose must be specially prepared and the freeness of pulp during the paper machine process must be adjusted to CSF 400 ml or more, preferably CSF 500 ml or more, but stocks rich in mechanical pulps have difficulty in adjusting the freeness.

To meet stricter demands for printing papers imposed by the diversification of printing systems, various techniques are being developed. Among them, a number of calender finishing techniques using hot calenders in place of conventional supercalenders were proposed and they were reported to increase the finishing speed and relatively improve print gloss, opacity and stiffness, etc., but it is also difficult to solve the problem of achieving low density even if rotogravure coated papers are prepared by only adopting this method.

In the preparation processes of rotogravure coated papers, it is also important to keep the highest possible quality and increase productivity to reduce costs. A means to achieve this is to increase the coating speed to improve coating runnability. However, it is necessary to use a coating solution with good coating runnability when the coating speed is increased, but if a normal coating is used at high coating speed, a high shear stress is applied to the coating transferred to the base paper when it is scraped with a blade, so that the viscosity of the coating color under a blade increase to cause stalactites, scratches, streaks, etc., thus resulting in poor runnability.

In JPA 2002-88679 (see Patent Reference 1), we showed that rotogravure coated papers having low density, high sheet gloss and improved gravure printability such as missing dots were obtained by using kaolin having a volume-based distribution in which 65% or more of particles are in the particle diameter range of 0.4-4.2 μm as a pigment in the coating layer in an amount of 50 parts by weight or more in 100 parts by weight of the total pigment composition and a latex copolymer having a glass transition temperature of −50 to 0° C. as an adhesive. However, stalactites, scratches, streaks, etc. sometimes occurred at coating speeds of 600 m/min or more, resulting in poor coating runnability.

Thus, it was difficult to obtain rotogravure coated papers having good runnability and desired properties by only adaptation of conventional techniques.

Patent Reference 1: JPA 2002-88679

Problems to Be Solved by the Invention

In view of the situation above, an object of the present invention is to provide a rotogravure coated paper having good runnability, low density, high gloss and good printability, as well as a preparation process thereof.

Means for Solving the Problems

We accomplished the present invention on the basis of the finding that rotogravure coated papers comprising a coating layer containing a pigment and an adhesive on a base paper can be efficiently prepared with good runnability, low density, high sheet gloss and print gloss, less missing dots during gravure printing and good printability when the coating layer contains an inorganic pigment having a volume-based distribution in which 65% or more of particles are in the particle diameter range of 0.4-4.2 μm and a hollow sphere synthetic pigment having a mean particle diameter of 0.1-0.6 μm.

Especially when the hollow sphere synthetic pigment having a small particle diameter as defined above is combined with the inorganic pigment having a volume-based distribution in which 65% or more of particles are in the particle diameter range of 0.4-4.2 μm and contained in an amount of 2-30 parts by weight per 100 parts by weight of the inorganic pigment, the coating color has an optimized viscosity and further improved coating runnability.

Gloss and smoothness are improved by calendering even at low linear pressures, and the coated paper has a lower density because of the low density of the synthetic pigment itself, while it has higher opacity and stiffness. The density of the coated paper can be further lowered by using a base paper containing 3-12% by weight of an amorphous silicate on the basis of the weight of the base paper. In contrast to conventional coating color which tend to readily penetrate low-density base papers containing an amorphous silicate and result in poor coating runnability and quality, coating color of the present invention containing an inorganic pigment having a specifically defined particle diameter and a hollow sphere synthetic pigment having a small particle diameter do not readily penetrate such base papers, thus providing good coating runnability and quality, such as gloss.

### PREFERRED EMBODIMENTS OF THE INVENTION

In the present invention, it is important that the coating layer on the base paper should contain an inorganic pigment having a specific volume particle size distribution and a hollow sphere synthetic pigment having a small particle diameter.

It is important to use an inorganic pigment having a volume distribution in which 65% or more of coating pigment particles are in the particle diameter range of 0.40-4.20 μm. If pigments having a volume distribution shifted to smaller particle diameters are used, sheet gloss increases but print gloss decreases and coverage of the base paper also decreases as compared with pigments having a volume distribution shifted to greater particle diameters. Thus, it is difficult to prepare bulky rotogravure coated papers having good sheet appearance and printability by using a pigment composition rich in pigments having a volume distribution shifted to smaller particle diameters to decrease the coat weight and increase the basis weight of the base paper. If pigments having a volume distribution shifted to a greater mean particle diameter are used, print gloss and coverage of the base paper are improved, but it is difficult to prepare bulky rotogravure coated papers having good sheet appearance and printability, because sheet gloss becomes too much lower than that obtained with pigments having a volume distribution shifted to smaller particle diameters. High sheet gloss and print gloss and good coverage can be achieved by using an inorganic pigment having a volume distribution in which 65% or more of coating pigment particles are in the particle diameter range of 0.40-4.20 μm. The use of such a pigment makes it possible to decrease the coat weight and increase the basis weight of the base paper, thereby further lowering the density, because a coating layer having high sheet gloss and print gloss and good coverage can be obtained. The inorganic pigment used in the present invention is not specifically limited so far as it has a volume distribution in which 65% or more of coating pigment particles are in the particle diameter range of 0.40-4.20 μm, and a plurality of inorganic pigments can be used in combination without departing from the purpose of the present invention. Suitable inorganic pigments include conventional inorganic pigments used for coated papers, such as kaolin, clay, ground calcium carbonate, precipitated calcium carbonate, talc, titanium dioxide, barium sulfate, calcium sulfate, zinc oxide, silicic acid, silicate salts, colloidal silica and satin white, and these inorganic pigments can be used alone or in combination of two or more as appropriate. Preferably, 75 parts by weight or more of kaolin is included in 100 parts by weight of the inorganic pigment to improve printability.

It is important that the synthetic pigment used in the present invention should have a mean particle diameter of 0.1-0.6 μm and should be hollow. If the mean particle diameter is less than 0.1 μm, relatively poor gloss appears during calendering. If any synthetic pigment having a mean particle diameter exceeding 0.6 μm is used in combination with an inorganic pigment having a volume distribution in which 65% or more of coating pigment particles are in the particle diameter range of 0.40-4.20 μm, the resulting coating color has high viscosity and therefore poor coating runnability, which makes it difficult to obtain a uniform coating layer and leads to poor smoothness during calendering. When a hollow sphere synthetic pigment having a mean particle diameter as defined above is combined with an inorganic pigment having a volume-based distribution in which 65% or more of particles are in the particle diameter range of 0.4-4.2 μm and contained in an amount of 2-30 parts by weight per 100 parts by weight of the inorganic pigment, the resulting coating color has an optimized viscosity and further improved runnability. Other types of synthetic pigments such as solid pigments can be combined with a hollow sphere synthetic pigment having a particle diameter of 0.1-0.6 μm without departing from the purpose of the present invention.

The adhesive used in the coating layer of the present invention is not specifically limited, and a plurality of adhesives can be used in combination without departing from the purpose of the present invention. One or more conventional adhesives for coated papers are appropriately selected, e.g. synthetic adhesives such as styrene-butadiene copolymers, styrene-acrylic copolymers, ethylene-vinyl acetate copolymers, butadiene-methyl methacrylate copolymers, vinyl acetate-butyl acrylate copolymers, or maleic anhydride copolymers and acrylic-methyl methacrylate copolymers; proteins such as casein, soybean protein and synthetic proteins; starches such as oxidized starches, cationic starches, urea phosphate-esterified starches, etherified starches such as hydroxyethyl ether starches. These adhesives are used in a range of about 3-50 parts by weight, more preferably 3-12 parts by weight per 100 parts by weight of the inorganic pigment. The adhesive used in the present invention is preferably a latex copolymer having a glass transition temperature of −10° C. to −50° C. A coating layer having cushioning properties suitable for gravure printing can be obtained by using this range.

The coating color of the present invention may contain various common auxiliaries such as dispersants, water-retention agents, antifoamers and water resistance conferring agents. The auxiliaries used in the present invention are preferably synthetic acrylic water-retention agents and hydroxyethylcellulose, more preferably synthetic associative acrylic water-retention agents. Synthetic associative acrylic water-retention agents serve to improve the water retention of the coating solution and to decrease the high shear viscosity of the coating color. Thus, the coating solution becomes suitable for high-speed coating and the coating does not deeply penetrate the coating base paper, so that a bulky coating layer with improved cushioning properties is formed on the base paper, resulting in less missing dots during gravure printing. Hydroxyethylcellulose has similar effects, which are remarkable when delaminated clay is used as a pigment. When a synthetic acrylic water-retention agent and/or hydroxyethylcellulose are used, they are preferably contained in an amount of 0.1-1.0 parts by weight per 100 parts by weight of the inorganic pigment.

The base paper used in the present invention preferably contains 3-12% by weight of an amorphous silicate on the basis of the weight of the base paper. Lower density, higher print gloss, less missing dots, and better surface strength can be obtained by containing it in this range. To achieve lower density and better surface strength, it is desirable that the amorphous silicate should have a bulk specific gravity of 0.2-0.8 g/ml, more preferably 0.4-0.8 g/ml.

Amorphous silicate used as a filler in the present invention is a so-called white carbon filler. Amorphous silica is a kind of synthetic amorphous silica, also called white carbon or hydrated silica, and typically prepared by reacting sodium silicate (water glass) with sulfuric acid to give aggregates (SiO₂.nH₂O) of about 5-20 μm. These reaction products and other inorganic silicate salts such as aluminum compounds are collectively called amorphous silicates, including hydrated aluminum silicate, hydrated sodium aluminum silicate, hydrated calcium silicate, and hydrated magnesium silicate depending on their compositions. Fillers other than amorphous silicates, such as talc, kaolin, heavy calcium carbonate, light calcium carbonate and titanium oxide may be added.

The base paper may be prepared by any process for making acidic, neutral or basic papers using a Fourdrinier paper machine including a top wire or the like, a cylinder paper machine, a combination machine of both or a Yankee dryer machine or the like, and may also be a wood containing base paper containing recycled paper pulp obtained from old newspapers. Base papers precoated with starch or polyvinyl alcohol or precoated with a coating color containing a pigment and an adhesive in one or more layers using a size press, bill blade, gate roll coater, premetering size press or the like may also be used. Base papers having a basis weight of about 30-400, preferably 30-200 g/m² used for normal coated papers may be appropriately used as coating base papers.

The prepared coating color is applied in one or more layers on one or both sides of the base paper using a blade coater, bar coater, roll coater, air knife coater, reverse roll coater, curtain coater, size press coater, gate roll coater or the like. The coat weight range of the present invention is preferably 5 g/m² or more and 25 g/m² or less, more preferably 5 g/m² or more and 16 g/m² or less per side. In the present invention, good operability can be preferably achieved even at a high coating speed of 600 m/min or more, more preferably 1000 m/min or more.

Wet coating layers are dried by using e.g. a superheated steam cylinder, hot air dryer, gas heater dryer, electric heater dryer, infrared heater dryer or the like, alone in or combination.

Thus coated and dried paper as above is finished by smoothing in a supercalender, hot soft nip calender or the like. The paper can be treated by no calender. Effects of the present invention are especially remarkable in coated papers having a basis weight of 40 g/m² or more and 120 g/m² or less, and especially, the present invention is advantageous in that rotogravure coated papers having a sheet gloss of 70% or more and a density of 1.10 g/cm³ or less can be obtained.

### EXAMPLES

The following examples further illustrate the present invention without, however, limiting the invention thereto as a matter of course. Unless otherwise specified, parts and % in the examples mean parts by weight and % by weight, respectively. Coating solutions and the resulting rotogravure coated papers were tested by the following evaluation methods.

<Evaluation Methods>

(1) Volume distribution for mean particle diameter: determined using a laser diffraction-based particle size distribution analyzer available from MALVERN Instruments.

(2) Sheet gloss: determined according to JIS P 8142.

(3) Print gloss: determined according to JIS P 8142 on the surface of a print obtained by using a single-color rotogravure press of the type used for printing paper currency in the Ministry of Finance of the Japanese Government at a printing speed of 40 m/min and a printing pressure of 10 kgf/cm.

(4) Missing dots: visually evaluated on the coated paper bearing an image after printing by the single-color rotogravure printing process described above. ⊚: very good, ◯: good, Δ: slightly poor, ×: poor.

(5) Stiffness: determined according to JIS P 8143 and evaluated on the following criteria. ⊚: very good, ◯: good, Δ: slightly poor, ×: poor.

(6) Opacity: determined according to JIS P 8138 and evaluated on the following criteria. ⊚: very good, ◯: good, Δ: slightly poor, ×: poor.

(7) Coating runnability: determined on the basis of streaks, scratches and the flowability of the coating solution during blade coating and evaluated on the following criteria. ⊚: very good, ◯: good, Δ: slightly poor, ×: poor.

### Example 1

An inorganic pigment (volume distribution in the particle diameter range of 0.40-4.20 μm: 66.6%) consisting of 80 parts of engineered kaolin (ECLIPS650 available from Engelhard Corporation, volume distribution in the particle diameter range of 0.40-4.20 μm: 65.3%) and 20 parts of fine ground calcium carbonate (FMT-90 available from Fimatec Ltd., volume distribution in the particle diameter range of 0.40-4.20 μm: 71.9%) was dispersed with 0.2 parts of sodium polyacrylate as a dispersant based on the inorganic pigment in a Cellier mixer to prepare a pigment slurry having a solids content of 70%. To the thus obtained pigment slurry were added 10 parts of a hollow sphere synthetic pigment (MH5055 available from ZEON Corporation, mean particle diameter 0.5 μm), 10 parts of an alkali-thickening styrene-butadiene latex copolymer (glass transition temperature −20° C., gel content 85%), and 1 part of hydroxyethyl ether starch (PG295 available from Penford Corp.) and 0.2 parts of a synthetic associative acrylic water-retention agent (L-89 available from Alco Chemical) as well as water to give a coating color having a solids content of 58%.

A wood containing paper having a basis weight of 50 g/m² was used as a coating base paper, which contains 6% of hydrated sodium aluminum silicate (bulk specific gravity 0.4 g/ml) and 6% of talc as fillers based on the weight of the base paper as well as 30% by weight of a mechanical pulp.

The base paper was coated with the coating color on both sides at a coating weight of 11 g/m² per side using a blade coater at a coating speed of 800 m/min and dried to give a coated paper having a moisture content of 5.5%.

Then, the coated paper was passed through a supercalender with two nips at a roll temperature of 70° C., a linear calender pressure of 200 kg/cm, and a paper feed speed of 10 m/min to give a rotogravure coated paper.

### Example 2

A rotogravure coated paper was obtained by the same procedure as in Example 1 except that 12% by weight of talc was used as a filler in place of 6% of hydrated sodium aluminum silicate (bulk specific gravity 0.4 g/ml) and 6% of talc.

### Example 3

A rotogravure coated paper was obtained by the same procedure as in Example 1 except that 35 parts of the hollow sphere synthetic pigment (MH5055 available from ZEON Corporation, mean particle diameter 0.5 μm) was used in place of 10 parts.

### Example 4

A rotogravure coated paper was obtained by the same procedure as in Example 1 except that the coating speed was 1100 m/min.

### Comparative Example 1

A rotogravure coated paper was obtained by the same procedure as in Example 1 except that an inorganic pigment (volume distribution in the particle diameter range of 0.40-4.20 μm: 59.7%) consisting of 70 parts of US No. 1 clay (Ultra White 90 available from Engelhard Corporation, volume distribution in the particle diameter range of 0.40-4.20 μm: 59.8%), 20 parts of delaminated clay (Hydraprint available from Huber Corporation, volume distribution in the particle diameter range of 0.40-4.20 μm: 53.2%), and 10 parts of fine ground calcium carbonate (FMT-90 available from Fimatec Ltd., volume distribution in the particle diameter range of 0.40-4.20 μm: 71.9%) was used in place of the inorganic pigment (volume distribution in the particle diameter range of 0.40-4.20 μm: 66.6%) consisting of 80 parts of engineered kaolin (ECLIPS650 available from Engelhard Corporation, volume distribution in the particle diameter range of 0.40-4.20 μm: 65.3%) and 20 parts of fine ground calcium carbonate (FMT-90 available from Fimatec Ltd., volume distribution in the particle diameter range of 0.40-4.20 μm: 71.9%).

### Comparative Example 2

A rotogravure coated paper was obtained by the same procedure as in Example 1 except that 10 parts of a hollow sphere synthetic pigment (HP1055 available from Rohm and Haas, mean particle diameter 1.0 μm) was used in place of 10 parts of a hollow sphere pigment (MH5055 available from ZEON Corporation, mean particle diameter 0.5 μm).

### Comparative Example 3

A rotogravure coated paper was obtained by the same procedure as in Example 1 except that 10 parts of an organic solid pigment (V1007 available from ZEON Corporation, mean particle diameter 0.3 μm) was used in place of 10 parts of a hollow sphere pigment (MH5055 available from ZEON Corporation, mean particle diameter 0.5 μm).

### Comparative Example 4

A rotogravure coated paper was obtained by the same procedure as in Example 1 except that an inorganic pigment (volume distribution in the particle diameter range of 0.40-4.20 μm: 66.6%) consisting of 75 parts of engineered kaolin (ECLIPS650 available from Engelhard Corporation, volume distribution in the particle diameter range of 0.40-4.20 μm: 65.3%), 15 parts of fine ground calcium carbonate (FMT-90 available from Fimatec Ltd., volume distribution in the particle diameter range of 0.40-4.20 μm: 71.9%) and 10 parts delaminated clay (Hydraprint available from Huber Corporation, volume distribution in the particle diameter range of 0.40-4.20 μm: 53.2%) was used in place of the inorganic pigment (volume distribution in the particle diameter range of 0.40-4.20 μm: 66.6%) consisting of 80 parts of engineered kaolin (ECLIPS650 available from Engelhard Corporation, volume distribution in the particle diameter range of 0.40-4.20 μm: 65.3%) and 20 parts of fine ground calcium carbonate (FMT-90 available from Fimatec Ltd., volume distribution in the particle diameter range of 0.40-4.20 μm: 71.9%), and that no hollow sphere synthetic pigment was added.

The results are shown in Table 1.

TABLE 1

| | | Sheet | Print | | | | |
|---|---|---|---|---|---|---|---|
| | Density | gloss | gloss | Missing | | | Coating |
| | g/cm³ | % | % | dots | Stiffness | Opacity | runnability |
| Example 1 | 1.05 | 75 | 90 | ⊚ | ⊚ | ⊚ | ⊚ |
| Example 2 | 1.12 | 78 | 95 | ⊚ | ◯ | ◯ | ⊚ |
| Example 3 | 1.03 | 77 | 93 | ◯ | ⊚ | ⊚ | ◯ |
| Example 4 | 1.05 | 74 | 89 | ⊚ | ⊚ | ⊚ | ◯ |
| Comparative | 1.07 | 64 | 78 | Δ | ⊚ | ⊚ | X |
| example 1 | | | | | | | |
| Comparative | 1.04 | 68 | 83 | Δ | ⊚ | ⊚ | X |
| example 2 | | | | | | | |
| Comparative | 1.16 | 68 | 84 | ◯ | ◯ | ◯ | ⊚ |
| example 3 | | | | | | | |
| Comparative | 1.15 | 64 | 80 | ⊚ | X | X | Δ |
| example 4 | | | | | | | |

Advantages of the Invention

According to the present invention, rotogravure coated papers with good coating runnability, low density, high sheet gloss and print gloss, less missing dots and good printability can be efficiently obtained.

1. A rotogravure coated paper comprising a coating layer containing a pigment and an adhesive on a base paper, wherein the coating layer contains an inorganic pigment having a volume-based distribution in which 65% or more of particles are in the particle diameter range of 0.4-4.2 μm and a hollow sphere synthetic pigment having a mean particle diameter of 0. 1-0.6 μm.

2. The rotogravure coated paper of claim 1 characterized in that the hollow sphere synthetic pigment is contained in an amount of 2-30 parts by weight per 100 parts by weight of the inorganic pigment.

3. The rotogravure coated paper of claim 1 characterized in that 3-12% by weight of an amorphous silicate is contained on the basis of the weight of the base paper.

4. The rotogravure coated paper of claim 1 characterized in that 75 parts by weight or more of kaolin is included as an inorganic pigment component in 100 parts by weight of the inorganic pigment.

5. A process for preparing the rotogravure coated paper of claim 1.
